(19) United States
(12) Patent Application Publication
(10) Pub. No.: US 2026/0004977 A1
(43) Pub. Date: Jan. 1, 2026

(54) ELECTROCHEMICAL CAPACITOR

(71) Applicant: Panasonic Intellectual Property Management Co., Ltd., Osaka (JP)

(72) Inventor: Nao MATSUMURA, Osaka Fu (JP)

(73) Assignee: Panasonic Intellectual Property Management Co., Ltd., Osaka (JP)

(21) Appl. No.: 18/994,306

(22) PCT Filed: Jul. 21, 2023
(86) PCT No.: PCT/JP2023/026803

§ 371 Date: Jan. 14, 2025

(30) Foreign Application Priority Data
Jul. 29, 2022 (JP) 2022-121496
Jan. 30, 2023 (JP) 2023-011873

(51) Int. Cl. H01G 11/64; H01G 11/24; H01G 11/26; H01G 11/60; H01G 11/62

(52) U.S. Cl. CPC H01G 11/64; H01G 11/24; H01G 11/26; H01G 11/60; H01G 11/62

(57) ABSTRACT

An electrochemical capacitor includes a positive electrode, a negative electrode, and an electrolyte. The electrolyte contains a lactone compound and an additive. The additive is at least one selected from the group consisting of a siloxane compound and a silyl fluoride compound.

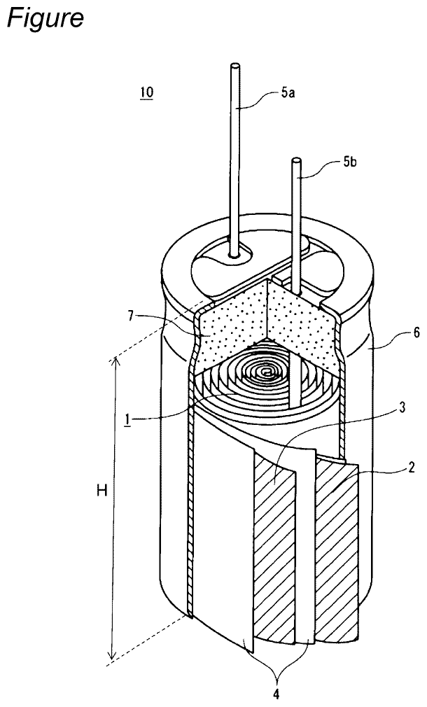

### TECHNICAL FIELD

The present disclosure relates to an electrochemical capacitor.

### BACKGROUND ART

Electrochemical capacitors include a pair of electrodes and an electrolyte, and at least one of the paired electrodes includes an active material capable of adsorbing and desorbing ions. Electric double layer capacitors, which are examples of the electrochemical capacitors, have a long life, can be rapidly charged, have excellent output characteristics, and are widely used, for example, as a backup power supply, as compared with secondary batteries.

Patent Literature 1 discloses an example of a nonaqueous electrolyte for electric double layer capacitor use in which N-ethyl-N-methyl pyrrolidinium tetrafluoroborate is dissolved as a quaternary ammonium salt and that contains 28.3 ppm of K⁺ and 0.4 ppm of Na⁺ as alkali-metal cations (Example 1).

### CITATION LIST

### Patent Literature

Patent Literature 1: International Publication No. 2016/092664

### SUMMARY OF INVENTION

### Technical Problem

The electrochemical capacitors tend to degrade in performance in float charging. Further improvements are therefore needed.

### Solution to Problem

In view of the above, one aspect of the present disclosure relates to an electrochemical capacitor including: a positive electrode; a negative electrode; and an electrolyte, wherein the electrolyte contains a lactone compound and an additive, and the additive is at least one selected from the group consisting of a siloxane compound and a silyl fluoride compound.

### Advantageous Effects of Invention

According to the present disclosure, degradation in floating characteristics of an electrochemical capacitor can be inhibited.

While the novel features of the invention are set forth particularly in the appended claims, the invention, both as to organization and content, will be better understood and appreciated, along with other objects and features thereof, from the following detailed description taken in conjunction with the drawings.

### BRIEF DESCRIPTION OF THE DRAWING

FIGURE is a partially cut-away perspective view of an electrochemical capacitor according to an embodiment of the present disclosure.

### DESCRIPTION OF EMBODIMENTS

Hereinafter, embodiments of the present disclosure are described below by way of examples, but the present disclosure is not limited to the examples described below. In the following description, specific numerical values and materials may be exemplified in some cases, but other numerical values and other materials may be adopted as long as the effects of the present disclosure can be obtained. In the present description, the phrase “a numerical value A to a numerical value B” means to include the numerical value A and the numerical value B, and can be replaced with “a numerical value A or more and a numerical value B or less”. In the following description, when the lower and upper limits of numerical values related to specific physical properties, conditions, or the like are mentioned as examples, any of the mentioned lower limits and any of the mentioned upper limits can be combined in any combination as long as the lower limit is not equal to or more than the upper limit. When a plurality of materials are mentioned as examples, one kind of them may be selected and used singly, or two or more types of them may be used in combination.

The present disclosure encompasses a combination of matters recited in any two or more claims selected from multiple claims in the appended claims. In other words, as long as no technical contradiction arises, matters recited in any two or more claims selected from multiple claims in the appended claims can be combined.

An electrochemical capacitor according to an embodiment of the present disclosure includes a positive electrode, a negative electrode, and an electrolyte. The electrolyte contains a lactone compound and an additive. The additive is at least one selected from the group consisting of a siloxane compound and a silyl fluoride compound.

The floating characteristics serve as an indicator of the degree of degradation of an electrochemical device when performing float charging. Here, the float charging is charging using an external DC power supply by which a constant voltage is maintained. It can be said that the floating characteristics are better as decrease in capacity is small and increase in internal resistance is small during float charging. The decrease in capacity and the increase in internal resistance are caused by electrolyte decomposition during float charging. It can be said that the smaller the amount of gas generated by electrolyte decomposition, the better the floating characteristics.

According to the present disclosure, even when the rated voltage of an electrochemical capacitor (electric double layer capacitor) is relatively high as 2.5 V or more (or 2.7 V or more), electrolyte decomposition can be inhibited to improve the floating characteristics.

The lactone compound, which has a low viscosity even at low temperatures, is used as a solvent of an electrolyte in electrochemical capacitors. Examples of the lactone compound include β-propiolactone, γ-butyrolactone, γ-valerolactone, and δ-valerolactone. Among them, γ-butyrolactone (GBL) is most preferable because it has a low viscosity even at low temperatures, has a high boiling point, and has a rate of gas emission resulting from side reactions.

However, in a situation in which the potential of the positive electrode is high, the lactone compound is placed in a strongly oxidizing environment. In strong acidic environments, the lactone compound may be oxidatively decomposed under influence of a surface functional group of the positive electrode active material. In float charging, a state in which a high voltage is applied to an electrochemical capacitor continues for a long period of time. This leads to a state in which the potential of the positive electrode remains high for a long period of time, and the lactone compound is susceptible to oxidative decomposition. It is considered that this results in gas generation, which leads to degradation of the floating characteristics.

According to the electrochemical capacitor of an embodiment of the present disclosure by contrast, as a result of the additive (either of both a siloxane compound and a silyl fluoride compound) being contained in the electrolyte containing a lactone compound, oxidative decomposition of the lactone compound is inhibited to suppress gas generation, thereby inhibiting degradation of the floating characteristics. It is inferred that this is because the additive reacts with the surface functional group (e.g., carboxyl group) of the positive electrode active material (porous carbon particles), resulting in the surface of the positive electrode active material being protected by a component (group) derived from the additive, thereby decreasing the reaction site of the positive electrode active material surface with the electrolyte component. It is inferred that oxidative decomposition of the lactone compound is inhibited by the additive silylating the surface functional group of the positive electrode active material. For example, a carboxyl group (COOH) on the surface of the positive electrode active material reacts with a silyl group (SiR₃, a decomposition product of the additive generated in aging treatment described later) derived from the additive to form COOSiR₃. SiR₃ is a trialkylsilyl group, for example.

When the above-described additive is used, gas generation during float charging is significantly suppressed, and degradation of the floating characteristics is remarkably inhibited. This is a unique effect when the solvent of the electrolyte contains a lactone compound.

If the solvent of the electrolyte is propylene carbonate, the amount of gas generated during float charging increases even when the above-described additive is used. During charging, the interface portion between the negative electrode and the electrolyte is in an alkaline environment while the interface portion between the positive electrode and the electrolyte is in an acidic environment. In the above situation, a hydrolysis reaction of the propylene carbonate occurs in the positive electrode and the negative electrode, tending to generate gas. In addition, the siloxane compound contains moisture, and is likely to be acidic or alkaline due to presence of moisture, thereby accelerating hydrolysis of the propylene carbonate. It is accordingly inferred that the amount of generated gas increases. By contrast, lactone compounds such as GBL are excellent in stability, and hardly decompose in an alkaline or acidic environment. Therefore, gas generation is suppressed.

From the point of view of further suppression of gas generation (swelling) during float charging, the electrolyte preferably contains a chain ester compound together with the lactone compound. The chain ester compound is preferably a condensate of an aliphatic monocarboxylic acid and a primary alcohol. Examples of such a chain ester compound include methyl acetate, ethyl acetate, propyl acetate, butyl acetate, methyl propionate, ethyl propionate, propyl propionate, butyl propionate, methyl butyrate, ethyl butyrate, propyl butyrate, and butyl butyrate. Among them, propyl acetate, methyl propionate, ethyl propionate, or methyl butyrate is particularly preferable in terms of, for example, boiling point, flash point, viscosity, and solubility.

### (Siloxane Compound)

The siloxane compound is a compound having a siloxane bond (Si—O—Si), and examples thereof include compounds represented by the following formula (1).

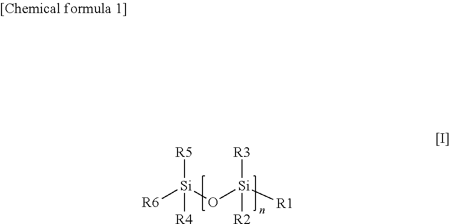

In general formula (1), R1 to R6 may each represent, independently of one another, a hydrocarbon group. Some of R1 to R6 may each be a hydrogen atom, a halogen atom, a hydroxy group, a carboxyl group, an amino group, an alkoxy group, or an ester group. From a point of view of viscosity and solubility in the electrolyte, n may be an integer of 1 or more and 10 or less, and preferably an integer of 1 or more and 5 or less. The number of carbon atoms of the hydrocarbon group may be, for example, 1 to 6, or 1 to 4. At least some of the hydrogen atoms of the hydrocarbon group may be substituted with a halogen atom. The hydrocarbon group may be a straight-chain, branched, or cyclic group. The hydrocarbon group may be a saturated hydrocarbon group or an unsaturated hydrocarbon group.

Examples of the hydrocarbon group include alkyl groups, cycloalkyl groups, aryl groups, alkenyl groups, and alkynyl groups. Examples of the alkyl groups include a methyl group, an ethyl group, an-propyl group, an isopropyl group, a n-butyl group, an isobutyl group, and a tert-butyl group. Examples of the cycloalkyl groups include a cyclopropyl group and a cyclobutyl group. Examples of the aryl groups include a phenyl group. Examples of the alkenyl groups include a vinyl group, a 1-propenyle group, a 2-propenyle group, an isopropenyle group, a 1-butenyle group, and a 2-butenylene group. Examples of the alkynyl groups include an ethynyl group.

Examples of the halogen atom include a fluorine atom, a chlorine atom, a bromine atom, and an iodine atom Examples of the alkoxy group include a methoxy group, an ethoxy group, and a propoxy group. At least some of the hydrogen atoms of the alkoxy group may be substituted with a halogen atom.

Examples of the siloxane compound include 1,1,3,3-tetramethyldisiloxane, hexamethyldisiloxane (HMDSi), 1,3-divinyltetramethyldisiloxane, octamethyltrisiloxane (OMTSi), and decamethyltetrasiloxane.

### (Silyl Fluoride Compound)

The silyl fluoride compound is a compound having a silyl fluoride group, and examples thereof include compounds represented by the following general formula (2).

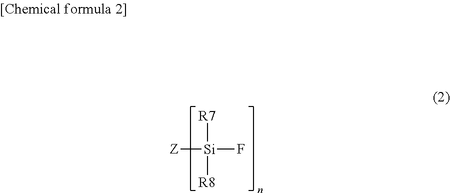

n is 1 or 2. The compounds represented by general formula (2) are compounds having n silyl fluoride group(s).

In general formula (2), when n=2, R7 and R8 may each represent, independently of one another, a hydrocarbon group. Examples of the hydrocarbon group include those exemplified by general formula (1). At least some of the hydrogen atoms of the hydrocarbon group may be substituted with a halogen atom. R7 or R8 may be a hydrogen atom, a halogen atom, a hydroxy group, a carboxyl group, an amino group, an alkoxy group, or an ester group. Examples of the halogen atom and the alkoxy group include those exemplified by general formula (1). At least some of the hydrogen atoms of the alkoxy group may be substituted with a halogen atom.

Z may be a divalent hydrocarbon group or a thio bond (—S—). Examples of the divalent hydrocarbon group include alkylene groups, alkeneylene groups, alkynylene groups, and cycloalkylene groups. Examples of the alkylene groups include a methylene group and an ethylene group. Examples of the alkenylene groups include a vinylene group. Examples of the alkynylene groups include an ethynylene group. Examples of the cycloalkylene groups include a cyclopropylene group and a cyclobutylene group.

In general formula (2), when n=1, Z, R7, and R8 may each represent, independently of one another, a hydrocarbon group. Examples of the hydrocarbon group include those exemplified by general formula (1). Some of Z, R7, and R8 may be a hydrogen atom, a halogen atom, a hydroxy group, a carboxyl group, an amino group, an alkoxy group, or an ester group. Examples of the halogen atom and the alkoxy group include those exemplified by general formula (1). At least some of the hydrogen atoms of the alkoxy group may be substituted with a halogen atom.

Examples of the fluoride silyl compound include: monofluorosilane compounds such as trimethylfluorosilane (CH₃)₃SiF), triethylfluorosilane, tripropylfluorosilane, phenyldimethylfluorosilane, triphenylfluorosilane, vinyldimethylfluorosilane, vinyldiethylfluorosilane, vinyldiphenylfluorosilane, trimethoxyfluorosilane, and triethoxyfluorosilane; difluorosilane compounds such as dimethyldifluorosilane, diethyldifluorosilane, divinyldifluorosilane, and ethylvinyldifluorosilane; and trifluorosilane compounds such as methyltrifluorosilane and ethyltrifluorosilane.

The siloxane compound to be added to the electrolyte may be decomposed by disconnecting the Si—O bond being a siloxane bond during aging treatment of the electrochemical capacitor. When there are a plurality of siloxane bonds, either or both a silyl fluoride compound and a siloxane compound that has a further smaller number of siloxane bonds may be generated as a decomposition product. When there is one siloxane bond, a silyl fluoride compound may be generated as a decomposition product The fluorine atom of the silyl fluoride compound may be derived from a fluorine atom of the anion of the electrolyte. Even after aging treatment of the electrochemical capacitor, a portion of the siloxane compound added during preparation of the electrolyte may remain without being decomposed.

The additive to be added to the electrolyte may be a siloxane compound having a plurality of siloxane bonds, and is more preferably octamethyltrisiloxane (OMTSi). OMTSi added to the electrolyte may form hexamethyldisiloxane (HMDSi) being a siloxane compound and trimethylfluorosilane ((CH₃)₃SiF) being a silyl fluoride compound during aging treatment of the electrochemical capacitor. Besides, instead of or in addition to the decomposition product of the siloxane compound, separately prepared siloxane compound and silyl fluoride compound may be directly added to the electrolyte in a necessary amount. In this case, the floating characteristics can be improved.

During preparation of the electrolyte (before aging treatment), the percentage content of the additive in the electrolyte is, for example, 0.01% by mass or more and 5% by mass or less relative to the entire electrolyte, and may be 0.1% by mass or more and 1% by mass or less. In the electrochemical capacitor, a portion of the additive may be consumed in a reaction with the surface functional groups of the positive electrode active material. Therefore, after aging treatment or after charging, a trace amount (e.g., 0.01% by mass or more) of the additive may be contained in the electrolyte.

For example, gas chromatography-mass spectrometry (GC/MS), ion chromatography (IC), or nuclear magnetic resonance spectroscopy (NMR) can be used for component analysis of the electrolyte.

The cation contained in the electrolyte is preferably a quaternary alkylammonium ion represented by NR₄⁺ (R represents an alkyl group) in terms of high withstand voltage and high solubility in aprotic solvents. The four alkyl groups R bonded to N may be different from one another or may be the same as one of the others. The four alkyl groups R may each represent, independently of one another, a C1-C4 alkyl group. Preferably, each of the alkyl groups R is a straight chain alkyl group with no branch, and a group in which two alkyl groups R are not bonded to each other to form a ring structure. Of all, diethyldimethylammonium ion (N(C₂H₅)₂(CH₃)₂⁺)) can be preferably used in view of easily reacting with OH that can be generated by decomposition of a trace amount of water and easily maintaining the pH of the electrolyte constant.

The quaternary alkylammonium ion is added to the electrolyte in the form of a salt with an anion. The anion is preferably an anion containing fluorine. Preferably, the anion includes an anion of a fluorine-containing acid. Examples of the fluorine-containing anion include BF₄⁻ and PF₆⁻.

Here, the capacity of the positive electrode is a maximum value of the capacity that can be exhibited in the positive electrode, and is a theoretical capacity determined according to, for example, the amount of the positive electrode active material. Similarly, the capacity of the negative electrode is a maximum value of the capacity that can be exhibited in the negative electrode, and is a theoretical capacity determined according to, for example, the amount of the negative electrode active material. The capacity of the positive electrode is a value generally obtained by multiplying the opposing area (cm²) between the positive electrode and the negative electrode by both the loading amount (g/cm²) per unit area of the positive electrode active material and the capacity (F/g) per unit weight of the positive electrode active material. The capacity of the negative electrode is a value generally obtained by multiplying the opposing area (cm²) between the positive electrode and the negative electrode by both the loading amount (g/cm²) per unit area of the negative electrode active material and the capacity (F/g) per unit weight of the negative electrode active material. The capacities (F) of the positive electrode active material and the negative electrode active material are each obtained from the amount of electric charge when 3 V is applied.

In the electrochemical capacitor, the larger the capacity of the positive electrode relative to the capacity of the negative electrode, the more the potentials of the positive electrode and the negative electrode decrease; and the larger the capacity of the negative electrode relative the capacity of the positive electrode, the more the potentials of the positive electrode and the negative electrode increase.

In the electrochemical capacitor according to an embodiment of the present disclosure, the capacity of the positive electrode may be set larger than the capacity of the negative electrode. As a result, the potential of the positive electrode during charging can be lowered, and oxidative decomposition of the lactone compound, which may cause degradation of the floating characteristics, is inhibited.

The larger the capacity of the positive electrode relative to the capacity of the negative electrode, the greater the effect of inhibiting oxidative decomposition of the lactone compound and the greater the effect of inhibiting degradation of the floating characteristics. In order to inhibit degradation of the floating characteristics, the capacity ratio of the positive electrode to the negative electrode is preferably 1.1 or more.

Besides, the larger the capacity of the positive electrode relative to the capacity of the negative electrode, the greater the portion of the capacity of the positive electrode that does not contribute to the capacity of the electrochemical capacitor, leading to a decrease in capacity of the electrochemical capacitor. Further, since the potential of the negative electrode decreases, reducibility is further increased on the negative electrode site. In view of suppressing a decrease in capacity of the electrochemical capacitor and inhibiting a side reaction (gas generation accompanied by a side reaction) due to reduction decomposition of the lactone compound in the negative electrode, the capacity ratio of the positive electrode to the negative electrode is preferably 1.6 or less.

In view of further inhibiting degradation of the floating characteristics caused due to gas generation, the capacity ratio of the positive electrode to the negative electrode is preferably 1.3 or more and 1.6 or less, and more preferably 1.3 or more and 1.5 or less.

Both the positive electrode and the negative electrode are polarizable electrodes. A polarizable electrode may contain an active material capable of adsorbing and desorbing ions. As a result of ions being adsorbed on the active material, the capacity is exhibited. As a result of ions being desorbed from the active material, a non-Faraday current flows. The electrochemical capacitor is an electric double layer capacitor (EDLC) in which an electric double layer is formed by ions adsorption onto the active material.

Polarizable electrodes include a current collector and a polarizable electrode layer carried on the current collector, for example. When both the positive electrode and the negative electrode are polarizable electrodes, the positive electrode includes a positive electrode current collector and a polarizable electrode layer carried on the positive electrode current collector, for example. The negative electrode includes a negative electrode current collector and a polarizable electrode layer carried on the negative electrode current collector, for example. The capacities of the positive electrode and the negative electrode each depend on the loading amount of the active material contained in the corresponding polarizable electrode layer, and each also depend on, for example, the specific surface area of the corresponding active material when the capacity is exhibited by ion adsorption onto the respective active material. However, by making the thickness of the polarizable electrode layer of the positive electrode larger than the thickness of the polarizable electrode layer of the negative electrode, the capacity of the positive electrode can be easily made larger than the capacity of the negative electrode.

Alternatively, the capacity of the positive electrode can be made larger than the capacity of the negative electrode by compressing the polarizable electrode layer of the positive electrode to increase the loading density of the active material per carrying area of the polarizable electrode layer on the positive electrode current collector, even though the thicknesses of the positive electrode and the negative electrode are set substantially the same.

The thickness of the polarizable electrode layer of the positive electrode is preferably larger than the thickness of the polarizable electrode layer of the negative electrode. The thickness ratio of the polarizable electrode layer of the positive electrode to the polarizable electrode layer of the negative electrode is more preferably 1.1 or more and 1.6 or less.

When the electrochemical capacitor is charged by applying a voltage of 3 V between the positive electrode and the negative electrode, the potential of the positive electrode is preferably in the range of +0.96 V or more and +1.0 V or less (the potential of the negative electrode is in the range of −2.04 V or more and −2.0 V or less) with reference to Ag/Ag⁺ potential. In this case, an electrochemical capacitor can be realized in which degradation of the floating characteristics is significantly inhibited.

Note that the potential of the positive electrode (negative electrode) is determined in a manner that the positive electrode and the negative electrode charged at 3 V are immersed in a nonaqueous solution having the same composition as that of the electrolyte so that the active material layers (polarizable electrode layers) face each other, and the potential is measured with the negative electrode (positive electrode) used as a counter electrode and the Ag electrode used as a reference electrode. When an active material layer (polarizable electrode layer) is provided on both sides of the positive electrode and the negative electrode, one active material layer (polarizable electrode layer) is removed from each one side of the positive and negative electrodes so as not to form non-opposed portions. As the Ag electrode, one can be used that is obtained by immersing a silver wire in an internal solution for reference electrode use filled in a glass tube. Here, the internal solution for reference electrode use is obtained by adding a solvent (GBL) to an electrolyte so that a salt concentration reaches 0.1 mol/L, and further adding AgBF₄ so that the Ag⁺ ion concentration reaches 0.1 mol/L.

Hereinafter, each component of the electrochemical capacitor according to an embodiment of the present invention will be described in more detail.

### (Positive Electrode and Negative Electrode)

For each of the positive electrode and the negative electrode of the electrochemical capacitor, for example, an electrode including an active layer (polarizable electrode layer) containing an active material and a current collector carrying the active layer is used as a polarizable electrode. The active material contains porous carbon particles, for example. The active layer contains the porous carbon particles being the active material as an essential component, and may contain, for example, a binder and a conductive agent as optional components.

The porous carbon particles can be produced, for example, by subjecting a raw material to heat treatment for carbonization, and then subjecting the resulting carbide to activation treatment to make it porous. The carbide may be crushed and sized before the activation treatment. The porous carbon particles resulting from the activation treatment may be pulverized. After the pulverization, classification may be performed. Examples of the activation treatment include gas activation using a gas such as water vapor, and chemical activation using an alkali such as potassium hydroxide.

Examples of the raw material include wood, coconut shell, pulp waste liquid, coal or coal-based pitch obtained by thermal decomposition thereof, heavy oil or petroleum-based pitch obtained by thermal decomposition thereof, phenolic resin, petroleum-based coke, and coal-based coke. Among them, petroleum-based coke or coal-based coke is preferable as the raw material.

The petroleum-based coke or the coal-based coke may be subjected to heat treatment, and the resulting carbide may be subjected to activation treatment, and then the resulting porous carbon particles may be pulverized. Pulverization may be performed using a ball mill or a jet mill, for example. By the above-described pulverization, fine porous carbon particles are obtained, of which mean particle diameter (D50) is 1 μm or more and 4 μm or less, for example. In the present description, the mean particle diameter (D50) means a particle diameter (median diameter) at which the volume accumulation value is 50% in a volume-based particle size distribution measured by a laser diffraction/scattering method.

The pore distribution and the particle size distribution of the porous carbon particles can be adjusted by changing the raw material, a heat treatment temperature, an activation temperature in gas activation, or a degree of pulverization, for example. In addition, the pore distribution and the particle size distribution of the porous carbon particles may be adjusted by mixing two types of porous carbon particles of which raw materials are different from each other.

The mean particle diameter and particle size distribution of the porous carbon particles are measured by the laser diffraction/scattering method. As a measuring device, a laser-diffraction/scattering particle size distribution measuring device “MT3300EX II” produced by MicrotracBEL Corp. is used, for example.

As the binder, carboxymethyl cellulose (CMC), styrene-butadiene rubber (SBR), or a resin material such as polytetrafluoroethylene (PTFE) is used, for example. As the conductive agent, carbon black such as acetylene black is used, for example.

The electrodes are obtained, for example, in a manner that a slurry containing the porous carbon particles, a dispersion medium, and either or both a binder and a conductive agent is applied onto a surface of a current collector, and the resulting coating film is dried and rolled to form an active layer. As the current collector, a metal foil such as an aluminum foil is used, for example.

### (Electrolyte)

The electrolyte contains a solvent (nonaqueous solvent), an ionic substance, and an additive. The ionic substance is dissolved in the solvent and contains a cation and an anion. The ionic substance may contain a low melting-point compound (ionic liquid) that can be present, for example, in the form of a liquid at around room temperature. The concentration of the ionic substance in the electrolyte is 0.5 mol/L or more and 2.0 mol/L, for example.

The solvent preferably has a high boiling point. The solvent contains a lactone compound, and may further contain an additional solvent (e.g., a chain ester compound) as necessary. Besides the chain ester compound, examples of the additional solvent that can be used includes: cyclic carbonates such as ethylene carbonate, propylene carbonate, and butylene carbonate; chain carbonates such as dimethyl carbonate, diethyl carbonate, and ethyl methyl carbonate; polyhydric alcohols such as ethylene glycol and propylene glycol; cyclic sulfones such as sulfolane; amides such as N-methylacetamide, N,N-dimethylformamide, and N-methyl-2-pyrrolidone; ethers such as 1,4-dioxane; ketones such as methyl ethyl ketone; and formaldehyde.

The ionic substance contains an organic salt, for example. The organic salt is a salt in which at least one of an anion and a cation contains an organic substance. Examples of the organic salt whose cation contains an organic substance include a quaternary ammonium salt. Examples of the organic salt whose anion (or both ions) contains an organic substance include trimethylamine maleate, triethylamine borodisalicylate, ethyldimethylamine phthalate, mono1,2,3,4-tetramethylimidazolinium phthalate, and mono1,3-dimethyl-2-ethylimidazolinium phthalate.

The anion preferably includes an anion of a fluorine-containing acid in view of improving withstand voltage characteristics. Examples of the anion of a fluorine-containing acid include BF₄⁻ and/or PF₆⁻. The organic salt preferably contains a cation of a quaternary alkylammonium and an anion of a fluorine-containing acid, for example. Specific examples thereof include diethyldimethylammonium tetrafluoroborate (DEDMABF₄) and triethylmethylammonium tetrafluoroborate (TEMABF₄).

### (Separator)

The separator is usually provided between the positive electrode and the negative electrode. The separator has ion permeability, and has a function of physically separating the positive electrode and the negative electrode to inhibit a short circuit. Examples of the separator that can be used include a nonwoven fabric made of cellulose fibers, a nonwoven fabric made of glass fibers, a microporous membrane made of polyolefin, a woven fabric, and a nonwoven fabric. The thickness of the separator is, for example, 8 to 300 μm, and preferably 8 to 40 μm.

FIGURE is a partially cut-away perspective view of an electrochemical capacitor according to an embodiment of the present disclosure.

An electrochemical capacitor 10 of FIGURE is an electric double layer capacitor and includes a capacitor element 1 of wound type. The capacitor element 1 is configured of a first electrode (positive electrode) 2 and a second electrode (negative electrode) 3 wound with a separator 4 therebetween, each of which has a sheet shape. The first electrode 2 and the second electrode 3 respectively include first current collector and second current collector made of a metal, and first active layer and second active layer supported on their respective surfaces, and each exhibit a capacity by adsorbing and desorbing ions. The first active layer and the second active layer each include porous carbon particles, for example.

For example, an aluminum foil is used as the current collector. The surface of the current collector may be roughened by a method such as etching. As the separator 4, a nonwoven fabric containing cellulose as a main component is used, for example. The first electrode 2 and the second electrode 3 are respectively connected to the first lead wire 5a and the second lead wire 5b each as an extraction member. The capacitor element 1 is housed in a cylindrical outer case 6 together with an electrolyte (not illustrated). The material of the outer case 6 should be a metal such as aluminum, stainless steel, copper, iron, or brass. The opening of the outer case 6 is sealed by a sealing member 7. The lead wires 5a and 5b are led outside so as to pass through the sealing member 7. For example, a rubber material such as butyl rubber is used as the sealing member 7.

Although a capacitor of wound type has been described in the above embodiment, the scope of application of the present disclosure is not limited to the above, and a capacitor having another configuration, such as a stack or coin-type capacitor may be applicable.

### SUPPLEMENTAL REMARKS

According to the above description of the embodiments, the following techniques are disclosed.

### Technique 1

An electrochemical capacitor including:
a positive electrode;
a negative electrode; and
an electrolyte, wherein
the electrolyte contains a lactone compound and an additive, and
the additive is at least one selected from the group consisting of a siloxane compound and a silyl fluoride compound.

### Technique 2

The electrochemical capacitor according to Technique 1, wherein the additive includes hexamethyldisiloxane as the siloxane compound and fluorotrimethylsilane as the silyl fluoride compound.

### Technique 3

The electrochemical capacitor according to Technique 1 or 2, wherein a capacitance ratio of the positive electrode to the negative electrode is 1.1 or more and 1.6 or less.

### Technique 4

The electrochemical capacitor according to any one of Techniques 1 to 3, wherein the positive electrode and the negative electrode each include a polarizable electrode layer, and a thickness of the polarizable electrode layer of the positive electrode is larger than a thickness of the polarizable electrode layer of the negative electrode.

### Technique 5

The electrochemical capacitor according to any one of Techniques 1 to 4, wherein the electrolyte comprises a chain ester compound.

### Technique 6

The electrochemical capacitor according to Technique 5, wherein the chain ester compound contains at least one selected from the group consisting of propyl acetate, methyl propionate, ethyl propionate, and methyl butyrate.

### Technique 7

The electrochemical capacitor of any one of Techniques 1 to 6, wherein the electrolyte contains a quaternary alkylammonium ion.

### Technique 8

The electrochemical capacitor of Technique 7, wherein the quaternary alkylammonium ion includes diethyldimethylammonium ion.

### Technique 9

The electrochemical capacitor of any one of Technique 1 to 8, wherein the lactone compound includes γ-butyrolactone.

The following describes the present disclosure in more detail based on examples, but the present disclosure is not limited to the examples.

### <<Capacitors A1 to A8 and B1 to B6>>

As electrochemical capacitors, electric double layer capacitors of wound type (diameter: 18 mm, length L: 70 mm) were produced. The following describes a specific method of producing the electrochemical capacitors.

### (Electrode Preparation)

A slurry was prepared by dispersing 88 parts by mass of porous carbon particles being an active material, 6 parts by mass of polytetrafluoroethylene (PTFE) being a binder, and 6 parts by mass of acetylene black being a conductive agent in water. The obtained slurry was applied onto an A1 foil (thickness: 30 μm), and the resulting coating film was dried by hot air at 110° C., and rolled to form an active layer (polarizable electrode layer). Thus, positive electrodes and negative electrodes were obtained. At that time, the thicknesses of the active layers of the positive electrodes and the negative electrodes were set to the values shown in Table 1. By the thickness setting, the capacity ratios of the positive electrodes to the negative electrodes were set to the values shown in Table 1.

### (Electrolyte Preparation)

Electrolytes were prepared by dissolving diethyldimethylammonium tetrafluoroborate (DEDMABF₄) in respective nonaqueous solvents, and adding octamethyltrisiloxane (OMTSi) as necessary. The compounds shown in Table 1 were used as the nonaqueous solvents. In Table 1, GBL refers to γ-butyrolactone, PC refers to propylene carbonate, and MP refers to methyl propionate. In Table 1, a mixed solvent containing GBL and MP with a volume ratio GBL: MP of 60:40 was used in capacitors A3 and A5. The concentration of the DEDMABF₄ in each electrolyte was set to 1.0 mol/L. The percentage content of the OMTSi in each electrolyte was set to 0.5 mass %.

### (Electrochemical Capacitor Production)

The positive electrodes and the negative electrodes were connected to respective lead wires, and wound with separators (thickness: 35 μm) therebetween to obtain capacitor elements. As the separators, a nonwoven fabric made of cellulose was used. The capacitor elements were each housed in a predetermined outer case together with the corresponding electrolyte, and each sealed with a sealing member. Thus, electrochemical capacitors (electric double layer capacitors) were produced. Thereafter, aging treatment was performed at 60° C. for 16 hours while the rated voltage was applied. With respect to electrochemical capacitors that used an electrolyte containing OMTSi, the respective electrolytes were collected after the aging treatment, and analyzed by a GC/MS method to detect hexamethyldisiloxane (HMDSi) and fluorotrimethylsilane.

In Table 1, A1 to A8 correspond to examples, and B1 to B6 correspond to comparative examples.

Each of the electrochemical capacitors obtained above was evaluated as follows.

### [Evaluation of Floating Characteristics]

The electrochemical capacitor after the aging treatment was subjected to constant current discharging at a current of 1.35 A in a 60° C. environment until the voltage reached 0 V. A height H1 (mm) of the electrochemical capacitor at that time was measured using a caliper. The height of the electrochemical capacitor is a maximum axial dimension H of the main body of the cylindrical electrochemical capacitor 10 illustrated in FIGURE.

Constant current charging at a current of 1.5 A was performed in a 60° C. environment until the voltage reached 2.8 V, after which the voltage was held at 2.8 V for 750 hours. In the manner described above, the electrochemical capacitor was stored in a state in which a voltage of 2.8 V was applied (float test). Thereafter, constant current discharging was performed at a current of 1.35 A in a 60° C. environment until the voltage reached 0 V. A height H2 (mm) of the electrochemical capacitor at that time was measured using a caliper.

A value obtained by subtracting H1 from H2 was determined as a swell (mm) of the electrochemical capacitor. A small swell indicates that gas generation during float charging is suppressed and the floating characteristics are good.

Evaluation results are shown in Table 1.

TABLE 1

| | Active layer thickness | | Capacity ratio of | | | | |
|---|---|---|---|---|---|---|---|
| | (μm) | | positive electrode | Electrolyte | | | |
| Electrochemical | Positive | Negative | to negative | | Quaternary | | Swell |
| capacitor | electrode | electrode | electrode | Solvent | ammonium salt | Additive | (mm) |
| B1 | 65 | 65 | 1 | PC | DEDMABF₄ | — | 2.12 |
| B2 | 65 | 65 | 1 | PC | DEDMABF₄ | OMTSi | 2.61 |
| B3 | 65 | 50 | 1.3 | PC | DEDMABF₄ | OMTSi | 3.81 |
| B4 | 65 | 50 | 1.3 | PC | DEDMABF₄ | — | 3.09 |
| B5 | 65 | 65 | 1 | GBL | DEDMABF₄ | — | 1.41 |
| B6 | 65 | 43 | 1.5 | GBL | DEDMABF₄ | — | 0.85 |
| A1 | 65 | 65 | 1 | GBL | DEDMABF₄ | OMTSi | 0.71 |
| A2 | 65 | 59 | 1.1 | GBL | DEDMABF₄ | OMTSi | 0.48 |
| A3 | 65 | 50 | 1.3 | GBL | DEDMABF₄ | OMTSi | 0.39 |
| A4 | 65 | 50 | 1.3 | GBL + MP | DEDMABF₄ | OMTSi | 0.30 |
| A5 | 65 | 43 | 1.5 | GBL | DEDMABF₄ | OMTSi | 0.38 |
| A6 | 65 | 43 | 1.5 | GBL + MP | DEDMABF₄ | OMTSi | 0.29 |
| A7 | 65 | 41 | 1.6 | GBL | DEDMABF₄ | OMTSi | 0.46 |
| A8 | 65 | 38 | 1.7 | GBL | DEDMABF₄ | OMTSi | 0.58 |

Given that the capacity ratio of the positive electrode to the negative electrode was 1, comparison between B1 and B5, both without OMTSi added, revealed that B1 in which the solvent of the electrolyte was PC had a larger swell than B5 in which the solvent of the electrolyte was GBL. It is considered that the hydrolysis reaction of PC occurred in the acid or alkali atmosphere, leading to easy occurrence of gas generation when using PC, while GBL hardly decomposed even in the acid or alkali atmosphere, thereby suppressing gas generation when using GBL.

A1 to A8 had a smaller swell than B1 to B6. In A2 to A7 having a capacity ratio of the positive electrode to the negative electrode of 1.1 or more and 1.6 or less, the swell was further small. In A4 and A6 that used the electrolyte further containing MP, the swell was further small.

In A1 in which OMTSi was added, oxidative decomposition of GBL was inhibited in the positive electrode to decrease the amount of generated gas, thereby decreasing the swell. In A8, also in which OMTSi was added, reduction decomposition of GBL was inhibited in the negative electrode to decrease the amount of generated gas, thereby decreasing the swell.

Comparison among B5, A1, and A2 that used the electrolyte containing GBL revealed that A1 had a smaller swell than B5, and A3 had a smaller swell than A1. In B5, OMTSi was not added to the electrolyte containing GBL, and the capacity ratio of the positive electrode to the negative electrode was 1. In A1, while OMTSi was added to the electrolyte containing GBL, the capacity ratio of the positive electrode to the negative electrode was 1. In A3, OMTSi was added to the electrolyte containing GBL, and the capacity ratio of the positive electrode to the negative electrode was 1.3.

By contrast, when comparing B1 and B2 that used the electrolyte containing PC, the swell was larger in B2 in which OMTSi was added than in B1 in which no OMTSi was added. Although detailed reason is unclear, it is considered that in the case using PC, PC hydrolyzed in the acid or alkali atmosphere to increase the amount of generated gas even when OMTSi was added.

Further, when comparing B2 and B3, the swell was larger in B3 with a capacity ratio of the positive electrode to the negative electrode of 1.3 than in B2 with a capacity ratio of 1. It is considered that the case with a capacity ratio of 1.3 resulted in a more alkaline atmosphere than the case with a capacity ratio of 1, facilitating the hydrolysis reaction of PC and resulting in a larger amount of generated gas.

From the above, it is understood that the effect of improving the floating characteristics by adding OMTSi to an electrolyte and setting the capacity ratio of the positive electrode to the negative electrode to 1.1 or more and 1.6 or less is a unique effect when using the electrolyte containing a lactone compound (GBL).

### INDUSTRIAL APPLICABILITY

The electrochemical device according to the present disclosure is suitably used in applications requiring large capacity and excellent floating characteristics.

Although the present invention has been described in terms of the presently preferred embodiments, it is to be understood that such disclosure is not to be interpreted as limiting. Various alterations and modifications will no doubt become apparent to those skilled in the art to which the present invention pertains, after having read the above disclosure. Accordingly, it is intended that the appended claims be interpreted to cover all alterations and modifications as fall within the true spirit and scope of the invention.

### REFERENCE SIGNS LIST

1: capacitor element, 2: first electrode, 3: second electrode, 4: separator, 5a: first lead wire, 5b: second lead wire, 6: outer case, 7: sealing member, 10: electrochemical capacitor

1. An electrochemical capacitor comprising:
a positive electrode;
a negative electrode; and
an electrolyte, wherein
the electrolyte contains a lactone compound and an additive, and
the additive is at least one selected from the group consisting of a siloxane compound and a silyl fluoride compound.

2. The electrochemical capacitor according to claim 1, wherein
the additive contains hexamethyldisiloxane as the siloxane compound and fluorotrimethylsilane as the silyl fluoride compound.

3. The electrochemical capacitor according to claim 1, wherein
a capacity ratio of the positive electrode to the negative electrode is 1.1 or more and 1.6 or less.

4. The electrochemical capacitor according to claim 1, wherein
the positive electrode and the negative electrode each include a polarizable electrode layer, and
a thickness of the polarizable electrode layer of the positive electrode is larger than a thickness of the polarizable electrode layer of the negative electrode.

5. The electrochemical capacitor according to claim 1 or 3, wherein
the electrolyte contains a chain ester compound.

6. The electrochemical capacitor according to claim 5, wherein
the chain ester compound include at least one selected from the group consisting of propyl acetate, methyl propionate, ethyl propionate, and methyl butyrate.

7. The electrochemical capacitor according to claim 1, wherein
the electrolyte contains a quaternary alkyl ammonium ion.

8. The electrochemical capacitor according to claim 7, wherein
the quaternary alkyl ammonium ion includes diethyldimethylammonium ion.

9. The electrochemical capacitor of claim 1, wherein
the lactone compound includes γ-butyrolactone.

10. The electrochemical capacitor according to claim 3, wherein
the positive electrode and the negative electrode each include a polarizable electrode layer, and
a thickness of the polarizable electrode layer of the positive electrode is larger than a thickness of the polarizable electrode layer of the negative electrode.

11. The electrochemical capacitor according to claim 3, wherein
the electrolyte contains a chain ester compound.

12. The electrochemical capacitor according to claim 11, wherein
the chain ester compound include at least one selected from the group consisting of propyl acetate, methyl propionate, ethyl propionate, and methyl butyrate.

13. The electrochemical capacitor according to claim 3, wherein
the electrolyte contains a quaternary alkyl ammonium ion.

14. The electrochemical capacitor according to claim 13, wherein
the quaternary alkyl ammonium ion includes diethyldimethylammonium ion.

15. The electrochemical capacitor of claim 3, wherein
the lactone compound includes γ-butyrolactone.
